(19) United States
(12) Patent Application Publication
(10) Pub. No.: US 2024/0294675 A1
(43) Pub. Date: Sep. 5, 2024

(54) RING-OPENING METATHESIS POLYMERIZATION

(71) Applicants: The Trustees of Boston College, Chestnut Hill, MA (US); Iowa State University Research Foundation, Inc., Ames, IA (US)

(72) Inventors: Jia Niu, Lexington, MA (US); Wenyu Huang, Ames, IA (US); Zefeng Zhou, Waltham, MA (US)

(73) Assignees: The Trustees of Boston College, Chestnut Hill, MA (US); Iowa State University Research Foundation, Inc., Ames, IA (US)

(21) Appl. No.: 18/589,967

(22) Filed: Feb. 28, 2024

Related U.S. Application Data
(60) Provisional application No. 63/487,513, filed on Feb. 28, 2023.

(51) Int. Cl. C08F 4/80; C08F 112/06; C08F 234/02

(52) U.S. Cl. CPC C08F 4/80; C08F 112/06; C08F 234/02

(57) ABSTRACT

This patent document provides a caged catalyst comprising a catalyst encapsulated in a cage compound of Formula I represented [Zr^{IV}₆O₄(OI)₄(linker)₆]). The catalysts demonstrated excellent activities and size selectivity in a model RCM reaction, suggesting successful encapsulation into MOFs. ROMP of cyclopentene mediated by G3@UiO-67 achieved significantly higher molecular weight and lower dispersity than the counterpart mediated by the free catalyst. The ultra-high molecular weight polymers generated by the encapsulated catalysts demonstrated significantly improved mechanical and adhesive properties compared to the low molecular weight counterparts and commercial polymers. The simplicity and generality make this method readily applicable to the ROMP of a wide range of low-strain cyclic olefins.

### CROSS-REFERENCE TO RELATED APPLICATIONS

This application claims priority to Provisional Application No. 63/487,513, filed Feb. 28, 2023, the disclosures of which is hereby incorporated by reference in the entirety.

### STATEMENT REGARDING FEDERALLY SPONSORED RESEARCH

This invention was made with government support under CHE 1944512, CHE 2305566, CHE 2304898, and CHE 2117246, which are awarded by the National Science Foundation. The government has certain rights in the invention.

### TECHNICAL FIELD

This patent document provides a caged polymerization catalyst comprising a catalyst encapsulated in a cage compound of Formula I represented [Zr^{IV}₆O₄(OH),(linker)₆]). The caged catalyst is capale of achieving significantly higher molecular weight and lower dispersity than the counterpart mediated by the free catalyst.

### BACKGROUND

Achieving precise control over molecular weight, dispersity, and polymer microstructures is a central goal in synthetic polymer chemistry. Leveraging highly efficient metathesis catalysts, ring-opening metathesis polymerization (ROMP) of cyclic olefins has produced a plethora of functional polymers spanning synthetic elastomers and biomimetic polymers. In particular, high molecular weight polymers produced by ROMP have shown great promise in advanced applications such as the biomedical implants and tribotechnical materials. However, to date, only high-strain cyclic olefins (e.g., norbornene, cyclobutene, etc.) can be polymerized by ROMP into polymers of high molecular weight and with living characteristics. ROMP of cyclic olefins with low or moderate ring strain remains prone to secondary metathesis such as intramolecular backbiting and intermolecular chain transfer, leading to polymers with low molecular weight and broad dispersity that hindered their applications.

Due to the strong motivation to develop sustainable polymers, there is an urgent need for new ROMP techniques that can efficiently synthesize high molecular weight polymers from low-strain monomers that are either derived from biobased feedstock, or consist of degradable moieties, or enable a circular polymerization-depolymerization life cycle.

### SUMMARY

The catalysts of this patent document address the need. The catalysts encapsulated into molecularly defined cages allow for efficient ring-opening metathesis polymerization of cyclic olefins. Different from conventional catalysts such as polymer-supported and silica-supported metathesis catalysts, the catalysts disclosed herein are positioned in molecular confinement and effectively reduce secondary metathesis.

An aspect of the patent document provides a caged catalyst for catalyzing a reaction, comprising a catalyst encapsulated in a cage compound of [Zr^{IV}₆O₄(OH)₄(linker)₆]).

In some embodiments, the linker is selected from benzene 1,4-dicarboxylic acid, 4,4′-biphenyl-dicarboxylic acid, 4,4″-terphenyl-dicarboxylic acid, 2 2′-bipyridine-5 5′-dicarboxylic acid, 2,2′-dimethyl-[1,1′-biphenyl]-4,4′-dicarboxylic acid, 3,3′-dihydroxy-[1,1′-biphenyl]-4,4′-dicarboxylic acid, 2-amino-[1,1′-biphenyl]-4,4′-dicarboxylic acid, and 2,2′-dinitro-[1,1′-biphenyl]-4,4′-dicarboxylic acid.

In some embodiments, the catalyst is a Ruthenium-based catalyst. In some embodiments, the catalyst comprises Ruthenium, wherein the Ruthenium ranges from about 0.01% to about 0.5% by weight over the total weight of the caged catalyst.

Another aspect of the patent document provides a method of synthesizing a polymer, comprising contacting a caged catalyst disclosed herein with one or more cyclic alkenes in a liquid phase.

In some embodiments, at least one of one or more cyclic alkenes contains at least five ring members. In some embodiments, the one or more cyclic alkenes contains at least two cyclic alkenes.

In some embodiments, the method further includes adding to the liquid phase an exogenous ligand to suppress dissociation of catalyst ligand. In some embodiments, the catalyst is selected so that the method produces the polymer in a molecular weight of at least 800 k daltons. In some embodiments, the catalyst is selected so that the method produces the polymer in a dispersity (D) of less than 1.50.

In some embodiments, the one or more cyclic alkenes comprise an alkylcyclyl alkene and a heterocyclyl alkene, wherein the caged catalyst increases incorporation of the heterocyclyl alkene by more than 50% in the polymer comparing with a reference catalyst not encapsulated in the cage compound.

In some embodiments, the catalyst is selected so that the method increases one or more of ultimate stress, strain, overall toughness, and lap shear strength of the polymer in comparison with a reference catalyst.

Another aspect of the document provides a method of preparing the caged catalyst, comprising
(a) mixing the catalyst and the cage compound in a first polar solvent;
(b) removing partially or completely the acetonitrile to collect a solid; and
(c) mixing the solid with a second polar solvent or a nonpolar solvent.

### DETAILED DESCRIPTION

Various embodiments of this patent document disclose polymerization catalysts for ROMP. The catalysts are encapsulated into molecularly defined cages, where monomer molecules will be allowed to access the propagating chain end of the polymer that is associated with the catalysts, while the nascent polymer chains outside of the cages are prevented from reaccessing the catalysts. During polymerization, the cages serve as selective physical barriers that inhibit intramolecular backbiting and intermolecular chain transfer, resulting in high processivity and the production of polymers of high molecular weights.

While the following text may reference or exemplify specific embodiments of a catalyst or a method of catalyzing a reaction, it is not intended to limit the scope of the catalyst or method to such particular reference or examples. Various modifications may be made by those skilled in the art, in view of practical and economic considerations, such as the substituions of the catalyst ligand and the amount of the catalyst for catalyzing a polymerization reaction.

The articles “a” and “an” as used herein refers to “one or more” or “at least one,” unless otherwise indicated. That is, reference to any element or component of an embodiment by the indefinite article “a” or “an” does not exclude the possibility that more than one element or component is present.

The term “alkyl” refers to monovalent saturated alkane radical groups particularly having up to about 18 carbon atoms, more particularly as a lower alkyl, from 1 to 8 carbon atoms and still more particularly, from 1 to 6 carbon atoms. The hydrocarbon chain may be either straight-chained or branched. The term “C₁-C₁₀ alkyl” or “C₁-C₁₀ alkyl” refers to alkyl groups having 1, 2, 3, 4, 5, 6, 7, 8, 9 or 10 carbon atoms. Similarly, the term “C₁₋₄alkyl” refers to alkyl groups having 1, 2, 3, or 4 carbon atoms. Non-limiting examples of alkyls include groups such as methyl, ethyl, n-propyl, isopropyl, n-butyl, iso-butyl, tert-butyl, n-hexyl, n-octyl, tert-octyl and the like.

The term “alkylcyclyl” refers to 3 to 10 membered cyclic hydrocarbyl groups having only carbon atoms as ring atoms and having a single cyclic ring or multiple condensed rings, including fused and bridged ring systems, which optionally can be substituted with from 1 to 3 alkyl groups. Such cycloalkyl groups include, by way of example, single ring structures such as cyclopropyl, cyclobutyl, cyclopentyl, cyclooctyl, 1-methylcyclopropyl, 2-methylcyclopentyl, 2-methylcyclooctyl, and the like, and multiple ring structures such as adamantanyl, and the like. The term “alkylcyclyl alkene” refers to a clyclic structure with only carbon atoms as ring members containing a double bond between two ring members.

The term “heterocycle” or “heterocyclyl” refers to 3 to 10 membered substituted or nonsubstituted non-armoatic cyclic groups where one or more carbon ring atoms are replaced with hetero atoms or groups containing heteroatoms (e.g. NH, NC1-C4alkyl O, and S). Nonlimnting examples include pyrrolidine, piperidine, N-methyl-piperizine, and morpholine. Optional substituents include C₁₋₆ alkyl, C₁₋₄ alkoxy, halogen, haloalkyl, sulfonamido, and amido. The term “heterocyclyl alkene” refers to a clyclic structure with 1 or more heteroatoms as ring members containing a double bond between two carbon ring members.

Hgh molecular weight polymers produced by ROMP have shown great promise in advanced applications such as the biomedical implants⁶ and tribotechnical materials. Conventional catalysts can only polymerize high-strain cyclic olefins (e.g., norbornene, cyclobutene, etc.) by ROMP into polymers of high molecular weight and with living characteristics. The catalysts disclosed herein overcome the limitations in olefin substrates and efficiently polymerize cyclic olefins with low or moderate ring strain with significantly reduced secondary metathesis such as intramolecular backbiting and intermolecular chain transfer, leading to polymers with high molecular weight and narrow dispersity.

An aspect of this patent document provides an encaged catalyst, wherein a catalyst encapsulated in a cage compound of Formula I represented [Zr^{IV}₆O₄(OH)₄(linker)₆]). During a polymerization process, monomer molecules are allowed to access the propagating chain end of the polymer that is associated with the catalysts, while the nascent polymer chains outside of the cages are prevented from reaccessing the catalyst. The cages serve as selective physical barriers that inhibit intramolecular backbiting and intermolecular chain transfer, resulting in high processivity and the production of polymers of high molecular weights.

Various linkers can be used for the cage compound. Nonlimiting examples include is benzene 1,4-dicarboxylic acid, benzene 1,4-dicarboxylic acid substituted with an amino or a carboxylic acid in the benzne ring, 4,4′-biphenyl-dicarboxylic acid, 4,4″-terphenyl-dicarboxylic acid, 2 2′-bipyridine-5 5′-dicarboxylic acid. The structures of some example linkers are shown below.

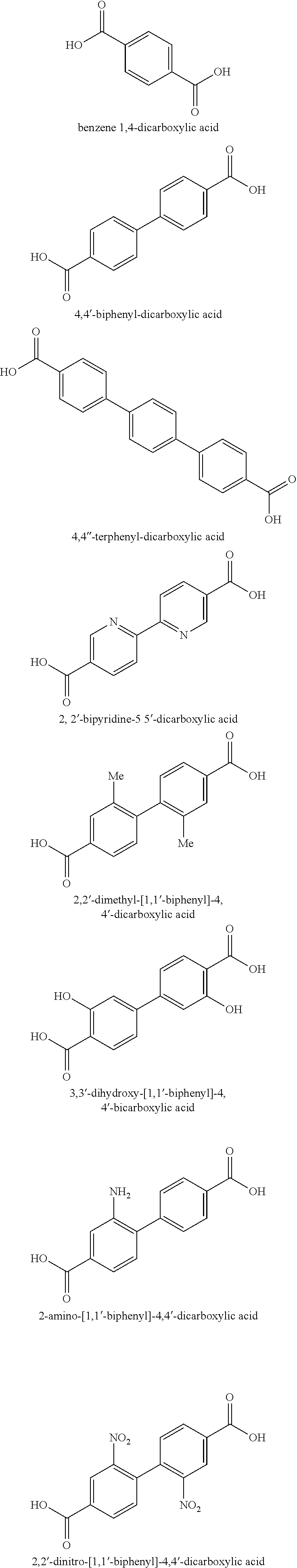

In some embodiments, the linker is selected from 2 2′-bipyridine-5 5′-dicarboxylic, 4,4′-biphenyl-dicarboxylic acid and benzene 1,4-dicarboxylic acid.

In some embodiments, the encaged catalyst provides a conversion rate of at least 10%, at least 12%, at least 14%, at least 16%, at least 18%, at least 20%, at least 30%, at least 40%, at least 50%, at least 60%, at least 70%, at least 80%, or at least 90% for an alkene monomer substrate within a time frame of about 10 minutes, about 30 minutes, aout 1 hour, about 2 hours, about 3 hours, about 4 hours, about 5 hours, about 6 hours, about 8 hours, about 10 hours, about 15 hours, or about 20 hours. The encaged catalyst for achieving the above conversion may be achieved with fresh and unrecycled, or recycled once, twice, three times, four times, or five times.

In some embodiments, the catalyst is a Ruthenium-based catalyst. In some embodiments, the catalyst is selected the following:

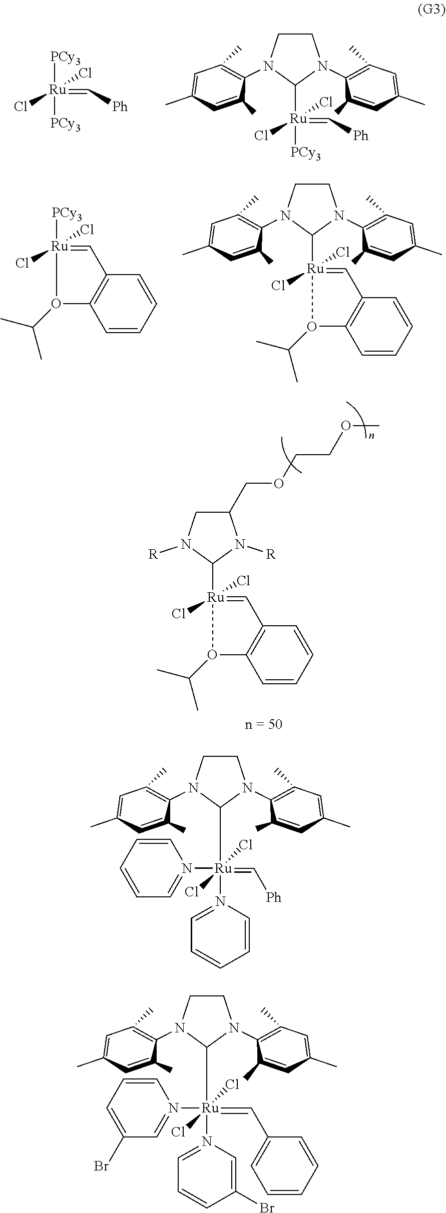

In some embodiments, the encaged catalyst comprises Ruthenium. In some embodiments, the Ruthenium ranges from about 0.01% to about 0.5%, from about 0.02% to about 0.3%, from about 0.02% to about 0.2%, from about 0.03% to about 0.15%, from about 0.03% to about 0.1% by weight over the total weight of the encaged catalyst. Nonlimiting examples of the amount of Ruthenium by weight in the encaged catalyst include about 0.01%, about 0.02%, about 0.03%, about 0.04%, about 0.05%, about 0.06%, about 0.07%, about 0.08%, about 0.09%, about 0.1%, about 0.15%, about 0.2%, about 0.25%, about 0.3%, and any range between any two of the aforementioned values.

In some embodiments, the Ruthenium ranges from about 0.1 mo % to about 5 mol %, from about 0.2 mo % to about 4 mol %, from about 0.4 mo % to about 4 mol %, from about 0.5 mo % to about 3 mol %, from about 1 mo % to about 2.5 mol %, or from about 1.5 mo % to about 2 mol % relative to the mole amount of the alkene substrate. Nonlimiting examples of the amount of Ruthenium relative to the total molar amount of the one or more alkene substrates include about 0.1 mo %, about 0.3 mo %, about 0.5 mo %, 0.8 mo %, 1.0 mo %, 1.2 mo %, 1.5 mo %, 2.0 mo %, 2.5 mo %, 3.0 mo %, 4.0 mo %, 5.0 mo %, and any range between any two of the aforementioned values.

In some embodiments, the encaged catalyst exhibits stronger resistancy to tertiary amines (e.g. trimethyl amine, triethyl amine, tri-n-butyl amine, tri-n-octyl amine, and alike) by at least 2 folds, at least 3 folds, at least 5 folds, at least 8 folds, at least 10 folds, at least 12 folds or at least 15 folds over a reference catalyst. Except without being encapsulated in the cage compound, the reference catalyst is identical to the catalyst component being encapsulated and is used in the same amount for polymerization reaction.

Another aspect provides a method of synthesizing a polymer, comprising contacting a encaged catalyst disclosed herein with one or more cyclic alkenes in a liquid phase. The cyclic alkenes in some embodiments contain 5, 6, 7, 8, 9 or 10 ring members. In some embodiments, the cyclic alkenes may contain 1, 2, 3 or more heteroatoms or substituted atoms (e.g. O, S, NH, NC₁₋₆alkyl, NC(O)C₁₋₆alkyl, etc).

In some embodiments, the method further includes introducing a ligand to the liquid phase to suppress dissociation of existing ligands of the catalyst. Nonlimiting examples of exogenous ligands include amines, heterocycles, and heteraromatics. In some embodiments, the exogenous ligand introduced to the liquid phase is selected from pyridine and 3-bromopyridine. The exogenous ligand

In some embodiments, the engaged catalyst is selected to produce the polymer in a molecular weight of at least 50 k, at least 80 k, at least 100 k, at least 200 k, at least 300 k, at least 500 k, least 600 k, least 700 k, at least 800 k, at least 1,000 k, at least 1,200 k, at least 1,300 k, at least 1,500 k, at least 1,800 k, at least 2,000 k, at least 3,000 k, at least 5,000 k, or at least 10,000 k daltons.

In some embodiments, in comparison with a reference catalyst without being encapsulated by the cage compound, the encaged catalyst is selected to increase the molecular weight of the polymer product by at least 2 folds, at least 3 folds, at least 5 folds, at least 8 folds, at least 10 folds, at least 12 folds, at least 15 folds or at least 20 folds.

In some embodiments, the engaged catalyst is selected to produce the polymer in a dispersity (D) of less than 1.80, less than 1.60, less than 1.50, less than 1.40, less than 1.30, less than 1.20, less than 1.15, or less than 1.10.

In some embodiments, the one or more cyclic alkenes include at least two cyclic alkenes, at least three cyclic alkenes, or at least four cyclic alkenes. In some embodiments, two cyclic alkenes are present in the liquid phase. Besides cyclic alkenes with carbon atoms as all the ring members (alkylcyclyl alkene), cyclic alkenes with one or more heteroatoms as ring members (heterocyclyl alkene) can also be used as monomer starting material. Nonlimiting examples of cyclic alkenes with heteroatoms as ring members include the following. R in each instance can be H, C₁₋₆alkyl, NH, or NC₁₋₆alkyl.

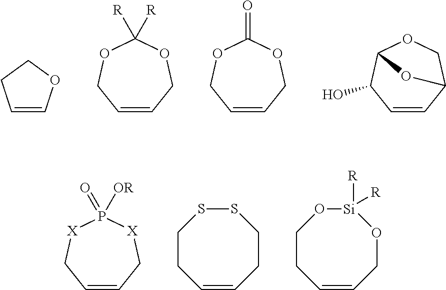

In some embodiments, the monomer substrates include an alkylcyclyl alkene and a heterocyclyl alkene. In some embodiments, in comparison with a reference catalyst, the encaged catalyst increases incorporation of the heterocyclyl alkene by more than 20%, more than 30%, more than 40%, more than 50%, more than 60%, more than 70%, more than 80%, more than 100%, more than 120%, more than 150%, more than 200%, more than 300%, more than 400% or more than 500%.

In some embodiments, the encaged catalyst increases one or more of adhesive property, ultimate stress, strain, overall toughness, degradability and lap shear strength of the polymer than from a reference catalyst not encapsulated in the cage compound. Each of the above parameters may be independently increased or improved by by more than 20%, more than 30%, more than 40%, more than 50%, more than 60%, more than 70%, more than 80%, more than 100%, more than 120%, more than 150%, more than 200% or more than 300%.

Another aspect of the patent document provides a method of preparing the caged catalyst disclosed herein. The method includes: mixing the catalyst and the cage compound a first polar solvent; removing partially or completely the first polar solvent to collect a solid; and mixing the solid with a nonpolar solvent or a second polar solvent. In some embodiments, the first polar solvent is more polar than the second polar solvent. Nonlimiting examples of polar solvents (first or second) include acetonitrile, ethyl acetate, acetone, methanol, ethanol, propanol, dichloromethane, chloroform, tetrahdrofuran, and any mixture thereof. In some embodiments, the first polar solvent in step (a) is acetonitrile or methanol or a mixture thereof. In some embodiments, the solvent for step (c) is dichloromethane, chloroform, tetrahdrofuran, or any mixture thereof.

### EXAMPLES

### Example 1

Materials: Hoveyda-Grubbs second-generation catalyst (HG2) (Sigma-Aldrich, 97%), Grubbs catalyst (G3) (Combi-block, 95%), zirconium (IV) chloride (Thermo Scientific Chemicals, 99.5+%), terephthalic acid (Thermo Scientific Chemicals, 99+%), 4,4′-biphenyldicarboxylic acid (TCI, >97%).

### Synthesis of UiO-66

To a 20 mL scintillation vial, a solution of 26.6 mg of terephthalic acid in 5.0 mL DMF and a solution of 18.6 mg ZrCl₄ and 2.0 mL acetic acid in 3.0 mL DMF were added. The vial was sealed and heated at 100° C. in a preheated oil bath for 24 hours. After the reaction mixture was cooled to room temperature, the supernatant was removed with a glass pipette, and the white crystals at the bottom were agitated by swirling the vail gently, followed by transferring it to a conical tube. The mixture was centrifuged at 3000 rpm for 10 min. The supernatant was decanted and the fresh DMF was replenished, and the white crystals were dispersed by vortex and sonicating. The mixture was sat for 3 hours before the next round of centrifugation. Three cycles were done with DMF, followed by three cycles of washing with methanol. The crystals were transferred to a vial with a septum top and were dried at 110° C. under vacuum for 12 hours, followed by refilling with N₂ and cooling down to room temperature. The UiO-66 was stored under N₂ in a glovebox at room temperature.

### Synthesis of UiO-67

To a 20 mL scintillation vial, a solution of 19.38 mg of 4,4′-biphenyldicarboxylic acid and 0.12 mL of triethylamine in 6.38 mL DMF and a solution of 18.64 mg ZrCl₄, 1.24 mL acetic acid in 3.76 mL DMF, and additional 11.5 mL of DMF were added. The vial was sealed and heated at 85° C. in a preheated oil bath for 24 hours. After the reaction mixture was cooled to room temperature, the supernatant was removed with a glass pipette, and the white crystals at the bottom were agitated by swirling the vial gently, followed by transferring to a conical tube. The mixture was centrifuged at 3000 rpm for 10 min. The supernatant was decanted and the fresh DMF was replenished, and the white crystals were dispersed by vortex and sonicating. The mixture was sat for 3 hours before the next round of centrifugation. Three cycles were done with DMF, followed by three cycles of washing with methanol. The crystals were transferred to a vial with a septum top and were dried at 110° C. under vacuum for 12 hours, followed by refilling with N₂ and cooling down to room temperature. The UiO-67 was stored under N₂ in a glovebox at room temperature.

### Encapsulation of Catalysts

HG2@UiO-66 or HG2@UiO-67: To a 20 mL scintillation vial charged with 100 mg UiO-66 or UiO-67 and a PTFE stirring bar, a solution of 10 mg HG2 in 3 mL anhydrous acetonitrile was added in a N₂ glovebox. The vial was sealed a screw top and tape, and the mixture was stirred for 72 hours under ambient conditions. The vial was transferred into a N₂ glovebox, and the mixture was poured into a conical tube, followed by the addition of 15 mL of anhydrous DCM. The mixture was vortexed and centrifuged at 3000 rpm for 10 min. The supernatant was decanted and the solid was further washed with anhydrous DCM for another 5 times. The solid was transferred to a vial with a septum cap and dried at room temperature under vacuum (0.1 mbar) for 12 hours, followed by refilling with N₂. The encapsulated catalysts were stored under N₂ in a glovebox in the freezer.

G3@UiO-66 or G3@UiO-67: To a 20 mL scintillation vial charged with 100 mg UiO-66 or UiO-67 and a PTFE stirring bar, a solution of 10 mg G3 and 6 μL 3-bromopyridine in 3 mL anhydrous acetonitrile was added in a N₂ glovebox. The vial was sealed a screw top and tape, and the mixture was stirred for 24 hours under ambient conditions. The vial was transferred into a N₂ glovebox, and the mixture was poured into a conical tube, followed by the addition of 15 mL 200 ppm of 3-bromopyridine in anhydrous DCM. The mixture was vortexed and centrifuged at 3000 rpm for 10 min. The supernatant was decanted and the solid was further washed with 3-bromopyridine/DCM solution for another 4 times. The solid was transferred to a vial with a septum cap and dried at room temperature under vacuum (0.1 mbar) for 12 hours, followed by refilling with N₂. The encapsulated catalysts were stored under N₂ in a glovebox in the freezer.

### Preparation of Control Sample, HG2/UiO-67

To a 20 mL scintillation vial charged with 100 mg UiO-67 and a PTFE stirring bar, a solution of 10 mg HG2 in 3 mL anhydrous dichloromethane was added in a N₂ glovebox. The vial wash sealed a screw top and tape, and the mixture was stirred for 10 min. The mixture was poured into a conical tube, followed by the addition of 15 mL of anhydrous DCM. The mixture was vortexed and centrifuged at 3000 rpm for 10 min. The supernatant was decanted and the solid was further washed with anhydrous DCM for another 3 times. The solid was transferred to a vial with a septum cap and dried at room temperature under vacuum (0.1 mbar) for 12 hours, followed by refilling with N₂. The encapsulated catalysts were stored under N₂ in a glovebox in the freezer.

### Ru Loading Determination by ICP-OES

ICP-OES Standard preparation: Six standards were prepared by dilution from commercially available zirconium (999±5 ppm) standards using serial dilution in grade A volumetric glassware to cover the expected concentration ranges (50-2000 ppb).

Digestion of encapsulated catalysts: Encapsulated catalyst (˜2 mg) was weighed into a 20 mL glass scintillation vial. Concentrated hydrochloric acid (0.5 mL) was added into the vial and the mixture was sonicated until all the powder was dispersed (ca. 3 min). 2 mL of ultrapure water (Milli-Q) was added, and the mixture was sonicated for 30 min. The digested sample was diluted to 10 mL with additional ultrapure water using a volumetric flask, filtered with 0.22 um PTFE syringe filter, and analyzed by ICP-OES against standards.

UiO-type MOFs were chosen as the host because of their superior thermal, chemical, and mechanical stabilities, and their versatility for post-synthetic encapsulation of guest molecules. The encapsulation of Hoveyda-Grubbs second-generation catalyst (HG2) and the third-generation Grubbs catalyst (G3) into the cages in UiO-66 and UiO-67 using the aperture-opening encapsulation approach was investigated. The sizes of octahedral cages in UiO-66 (˜10.7 Å) and UiO-67 (˜15.6 Å)³⁰ are estimated to be slightly larger than the size of HG2 (14.3 Å×10.7 Å×6.5 Å) and G3 (14.3 Å×9.4 Å×6.5 Å). Meanwhile, the sizes of triangular windows of the octahedral cages in UiO-66 (˜8.3 Å) and UiO-67 (˜11.1 Å) are smaller than the size of HG2 and G3, such that leaching of the encapsulated catalysts is prevented after the aperture is closed. The aperture-opening encapsulation was performed by first incubating the catalysts and the MOFs in acetonitrile at room temperature for 72 hours for HG2 or 24 hours for G3, before the solvent was switched to dichloromethane to keep the apertures closed.

Furthermore, alternating dichloromethane wash and short sonication cycles were repeated six times to remove physically adsorbed catalysts on the exterior of the MOFs. ¹H NMR spectroscopy confirmed that HG2 and G3 remained stable under the encapsulation and washing conditions. The crystallinity, morphology, size, and porosity of both UiO-66 and UiO-67 before and after the encapsulation procedure remain largely unchanged, evidenced by powder X-ray diffraction (PXRD), scanning electron microscopy (SEM), transmission electron microscopy (TEM), and Brunauer-Emmett-Teller (BET) surface area analysis. The ruthenium loading after encapsulation for four different encapsulated catalysts, namely HG2@UiO-66, HG2@UiO-67, G3@UiO-66, and G3@UiO-67, was determined by ICP-OES to be 0.020-0.10 wt %. UiO-67 with larger cages were found to encapsulate ˜40% more of both Ru-based catalysts than UiO-66. The catalytic activities of the encapsulated catalysts were evaluated using a ring-closing metathesis (RCM) reaction of diallyl ether. Under the same catalyst loading, HG2@UiO-67 and G3@UiO-67 showed markedly higher turnover frequency (TOF) in the RCM reaction than HG2@UiO-66 and G3@UiO-66 suggesting the larger cage of UiO-67 enabled better mass transport and provided adequate space for the encapsulated catalyst to interact with the substrate.

To confirm that the catalyst has been encapsulated into the cage rather than physically adsorbed on the exterior of the MOF matrix, a control catalyst, HG2/UiO-67 was constructed, by subjecting UiO-67 and HG2 in dichloromethane in which the aperture remains closed. Following the same washing process and loading measurement, the HG2/UiO-67 was found to exhibit 0.0031 wt % of Ru loading, which is two orders of magnitude lower than HG2@UiO-67. Furthermore, no RCM reactivity was observed for HG2/UiO-67. These results suggest that the washing procedure can efficiently remove the physically adsorbed catalyst and that the aperture-opening encapsulation procedure could indeed encapsulate metathesis catalysts into the cage of UiO-type MOFs.

Size-selectivity is a hallmark of MOF-encapsulated catalysts. When subjected to tertiary amine inhibitors of different sizes, HG2@UiO-67 and free HG2 demonstrated distinct properties. While trimethylamine could inhibit both HG2@UiO-67 and HG2 effectively, HG2@UiO-67 became significantly more resistant to tertiary amines with longer alkyl substitutions, exhibiting 2.9- to 7.8-folds higher activity in the model RCM reaction after being exposed to tertiary amines with ethyl substitutions or longer. It is noteworthy that, unlike HG2@UiO-67, HG2/UiO-67 did not exhibit significant resistance to tertiary amine inhibitors. Furthermore, two RCM substrates of different sizes, diallylmalonate and dihexyl 4,4′-((allyl(4-(allyl(hydrosulfonyl)amino)but-2-yn-1-yl)amino)sulfonyl)dibenzoate, were subjected to either HG2 or HG2@UiO-67. The observed rate constant of diallylmalonate was 1.3-fold higher than that of dihexyl 4,4′-((allyl(4-(allyl(hydrosulfonyl)amino)but-2-yn-1-yl)amino)sulfonyl)dibenzoate when the reactions were catalyzed by free HG2. In contrast, this ratio increased to 13.3 when the reactions were catalyzed by HG2@UiO-67. Taken together, these results can all be attributed to the impedance of the diffusion of large molecules by the MOF cage, thereby confirming that the catalyst has indeed been encapsulated within the MOF cage in HG2@UiO-67.

### Example 2

### Comparative Reactions of 1, 2 and 3

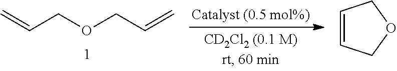

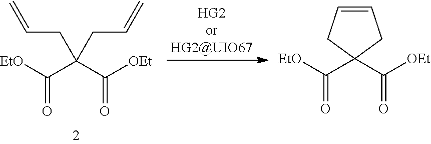 [SMILES: C=CCC(CC=C)(C(=O)OCC)C(=O)OCC ; CCOC(=O)C1(C(=O)OCC)CC=CC1]

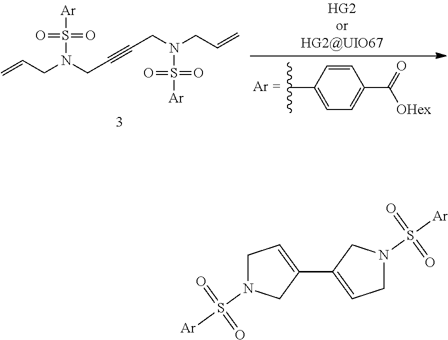

The Comparative reaction of 1 catalyzed by different encapsulated catalysts: In a N₂ glovebox, the encapsulated catalyst of designated amount (mass of catalyst was calculated based on Ru loading, 0.5 mol %) was weighted out in a 2 mL glass vial with a PTFE stirring bar. 500 μL of dichloromethane was added into the vial and the encapsulated catalyst was thoroughly dispersed by vortex and sonication. The solid was precipitated down by centrifugation at 3000 rpm for 3 min and the supernatant was removed. In the experiments with HG2@UiO-66 or HG2@UiO-67, a solution of allyl ether (10 μmol, 1 equiv.) in CD₂Cl₂ (0.1 mL) was added to the vial, followed by dispersing the encapsulated catalyst with vortex and sonication. In the experiments with G3@UiO-66 or G3@UiO-67, a solution of allyl ether (10 μmol, 1 equiv.) and 3,5-dichloropyridine (0.1 μmol, 0.01 equiv.) in CD₂Cl₂ (0.1 mL) was added instead. The reaction mixture was stirred at room temperature for 1 hour and quenched with one drop of ethyl vinyl ether. The solid was precipitated down and the supernatant was taken out for analysis by ¹H NMR. Turnover frequency (TOF) was calculated with the equation below.

$$TO F = \frac{conversion of 1 \times \frac{amount of 1}{amount of catalyst}}{time of reaction}$$

TABLE 1
Comparative reactions of 1 by HG2@UiO-66, HG2@UiO-
67, G3@UiO-66, and G3@UiO-67.

| Catalyst | Conv. | | | TOF (h⁻¹) | | | Average |
|---|---|---|---|---|---|---|---|
| HG2@UiO- | 9.9% | 10.0% | 11.5% | 20.6 | 19.9 | 19.1 | 19.9 ± |
| 66 | | | | | | | 0.8 |
| HG2@UiO- | 18.1% | 14.0% | 15.2% | 36.2 | 28.0 | 30.4 | 31.3 ± |
| 67 | | | | | | | 3.4 |
| G3@UiO- | 21.2% | 20.9% | 21.4% | 42.4 | 41.8 | 42.8 | 42.4 ± |
| 66 | | | | | | | 0.4 |
| G3@UiO- | 42.0% | 44.2% | 45.7% | 84.0 | 88.4 | 91.4 | 87.9 ± |
| 67 | | | | | | | 3.0 |

The Comparative reaction of 2 or 3 catalyzed by HG2: To a solution of 2 or 3 (24 μmol, 1 equiv.) in CD₂Cl₂ (0.4 mL) in a NMR tube, a solution of HG2 (0.24 μmol, 1.0 mol %) in CD₂Cl₂ (0.1 mL) was added under N₂ atmosphere. The tube was vortexed, and the reaction was analyzed with an array sampling every 2 min. Averaged conversions and standard deviations were calculated based on 3 replicates of experiments.

The Comparative reaction of 2 or 3 catalyzed by HG2@UiO-67: In a N₂ glovebox, HG2@UiO-67 of designated amount (mass of catalyst was calculated based on Ru loading, 0.25 mol %) was weighted out in a 2 mL glass vial with a PTFE stirring bar. 500 μL of solvent of reaction was added into the vial and the encapsulated catalyst was thoroughly dispersed by vortex and sonication. The solid was precipitated down by centrifugation at 3000 rpm for 3 min and the supernatant was removed. A solution of 2 or 3 (17.6 μmol, 1 equiv.) in CD₂Cl₂ (100 μL) was added to the vial, followed by dispersing the encapsulated catalyst with vortex and sonication. The reaction mixture was stirred at room temperature and quenched with one drop of ethyl vinyl ether at different time points. The solid was precipitated down and the supernatant was taken out for analysis by ¹H NMR.

Determination of conversion: The conversion was calculated based on the integrals of protons of reactant and product using the equations below.

For substrate 1:

$$conersion = \frac{\frac{integral of proton f}{4}}{\frac{integral of proton c and e}{2}} \times 100 \%$$

For substrate 2:

$$conersion = \frac{\frac{integral of proton f}{4}}{\frac{integral of proton d}{4} + \frac{integral of proton f}{4}} \times 100 \%$$

For substrate 3:

$$conersion = \frac{\frac{integral of proton f}{2}}{\frac{integral of proton f}{2} + \frac{integral of proton c}{2}} \times 100 \%$$

### Comparative Reactions in the Presence of Amines

In a N₂ glovebox, the HG2@UiO-67 of the designated amount (mass of catalyst was calculated based on Ru loading, 0.5 mol %) was weighted out in a 2 mL glass vial with a PTFE stirring bar. 500 μL of solvent of reaction was added into the vial and the encapsulated catalyst was thoroughly dispersed by vortex and sonication. The solid was precipitated down by centrifugation at 3000 rpm for 3 min and the supernatant was removed. A solution of amines (0.1 μmol, 0.5 mol %) in CDCl₃ (0.1 mL), and a solution of allyl ether (20 μmol, 1 equiv.) in CDCl₃ (0.1 mL) was added to the vial, followed by dispersing the encapsulated catalyst with vortex and sonication. The reaction mixture was stirred at room temperature for 20 minutes and quenched with one drop of ethyl vinyl ether. The solid was precipitated down and the supernatant was taken out for analysis by ¹H NMR. For the control experiment, CDCl₃ (0.1 mL) and a solution of allyl ether (20 μmol, 1 equiv.) in CDCl₃ (0.1 mL) were added to the vial, followed by the same treatment. The activity reaming was calculated by the equation below. Averaged results and standard deviations were calculated based on 3 replicates of experiments.

$$Activity Remaining = \frac{Conversion of 1 with amine}{Conversion of 1 without amine} \times 100 \%$$

### Example 3

ROMP of low-strain cyclic olefins by MOF-encapsulated catalysts. The ROMP of cis-cyclooctene, a model cyclic olefin with low ring strain was first examined. It has been well-documented that the ROMP of cis-cyclooctene suffers excessive secondary metathesis because of its low ring strain. To investigate if the catalyst processivity in the ROMP of cis-cyclooctene could be improved through MOF encapsulation of the catalyst, this reaction was performed using two MOF-encapsulated catalysts, HG2@UiO-67 and G3@UiO-67.

For G3@UiO-67: In a N₂ glovebox, 25 mg of G3@UiO-67 (mass of catalyst was calculated based on Ru loading, 1 equiv.) was weighed out in a 2 mL glass vial with a PTFE stirring bar. 500 μL of solvent of reaction was added into the vial and the encapsulated catalyst was thoroughly dispersed by vortex and sonication. The solid was precipitated down by centrifugation at 3000 rpm for 3 min and the supernatant was removed. A solution of 3-bromopyridine (1.73 μmol, 20 equiv.) in CDCl₃ (50 μL) was added to the vial, followed by dispersing the encapsulated catalyst with vortex and sonication. cis-Cyclooctene (15 μL, 115 μmol, 1330 equiv.) was added to the reaction at −10° C. The reaction mixture was stirred at −10° C. and quenched with one drop of ethyl vinyl ether at different time points. The reaction mixture was diluted with CDCl₃ (0.5 mL) and the solid was precipitated down (10000 rpm, 5 min). A small portion (20 μL) of supernatant was taken out for analysis by ¹H NMR. The rest of the supernatant was concentrated under vacuum to ˜ 0.1 mL and precipitated into 2 mL of MeOH. The precipitation redissolved and precipitated again and the polymer was analyzed by GPC and ¹H NMR. For ROMP of cis-cyclooctene by HG2@UiO-67, the condition was the same except the temperature of the reaction was 22° C.

For G3: In a N₂ glovebox, a solution of G3 (2.55 mg, 2.89 μmol, 1 equiv.) and 3-bromopyridine (57.7 μmol, 20 equiv.) in CDCl₃ (1.7 mL) was added to a 2 mL glass vial with a PTFE stirring bar. cis-Cyclooctene (0.5 mL, 3.85 mmol, 1330 equiv.) was added to the reaction at −10° C. The reaction mixture was stirred at −10° C. A portion of the reaction mixture (0.2 mL) was taken out at varying time points and quenched with one drop of ethyl vinyl ether. The reaction mixture was diluted with CDCl₃ (0.5 mL). A small portion (20 μL) of supernatant was taken out for analysis by ¹H NMR. The rest of the supernatant was concentrated under vacuum to ˜0.1 mL and precipitated into 2 mL of MeOH. The precipitation redissolved and precipitated again, and the polymer was analyzed by GPC and ¹H NMR. For ROMP of cis-cyclooctene by HG2, the condition was the same except the temperature of the reaction was 22° C.

TABLE 2
ROMP of cis-cyclooctene by HG2@UiO-
67, HG2, G3@UiO-67 and G3

| | Time | | M_{n, SEC} | |
|---|---|---|---|---|
| Catalyst | (min) | Conv. | (kg/mol) | Ð |
| HG2@UiO-67 | 10 | 2% | 495 | 1.61 |
| HG2@UiO-67 | 19 | 6% | 635 | 1.60 |
| HG2@UiO-67 | 27 | 13% | 777 | 1.46 |
| HG2@UiO-67 | 40 | 20% | 874 | 1.37 |
| HG2@UiO-67 | 59 | 36% | 935 | 1.36 |
| HG2 | 2 | 3% | 122 | 1.49 |
| HG2 | 3 | 7% | 162 | 1.67 |
| HG2 | 5 | 16% | 284 | 1.77 |
| HG2 | 6 | 27% | 353 | 1.75 |
| HG2 | 10 | 51% | 499 | 1.57 |
| G3@UiO-67 | 168 | 4% | 231 | 1.27 |
| G3@UiO-67 | 333 | 7% | 507 | 1.23 |
| G3@UiO-67 | 502 | 10% | 749 | 1.21 |
| G3@UiO-67 | 710 | 16% | 977 | 1.23 |
| G3@UiO-67 | 1219 | 23% | 1273 | 1.13 |
| G3 | 16 | 9% | 25 | 1.35 |
| G3 | 33 | 17% | 52 | 1.61 |
| G3 | 51 | 24% | 81 | 1.91 |
| G3 | 70 | 30% | 113 | 2.10 |
| G3 | 90 | 35% | 147 | 2.06 |

While HG2@UiO-67 resulted in a two-fold improvement of molecular weight and a modest reduction in dispersity, it did not improve the control over the polymerization as the molecular weight remained constant regardless of the conversion. The lack of control could be attributed to the slow rate of initiation of HG2 in ROMP than the rate of propagation, leading to disparate lengths of polymer chains. In contrast, the reaction mediated by fast-initiating G3@UiO-67 exhibited living characteristics including first-order kinetics to the monomer, linear growth of molecular weight of the resulting polyoctenamer versus the conversion, and low dispersity (D=1.13), in addition to producing ultra-high molecular weight polyoctenamers up to Mₙ=1,219 kg/mol. Meanwhile, free G3 under the same condition and at similar conversion produced a polyoctenamer with much lower molecular weight (Mₙ=81 kg/mol) and higher dispersity (D=1.91). It is noteworthy that the addition of an exogenous ligand 3-bromopyridine was necessary to suppress the fast dissociation of the pyridinyl ligand of G3 and maintain the structural integrity of the cage-encapsulated G3. We also confirmed that the ROMP reaction was mediated by the MOF-encapsulated catalysts, rather than active catalysts leaching into the solution from the MOF. When the G3@UiO-67 solid was separated from the ROMP reaction of cis-cyclooctene, monomer conversion in the supernatant completely halted, suggesting that no active catalyst was leached into the supernatant.

### Example 4

Next, G3@UiO-67 was applied to the copolymerization of cis-cyclooctene and cis-4,7-dihydro-1,3-dioxepin (DXP), a comonomer that incorporates degradable motifs in the polymer backbone. For the copolymerization of COE and DXP, the condition was the same as the polymerization catalyzed by G3@UiO-67 or G3 except a mixture of COE (115 μmol) and DXP (12.8 μmol) was added instead of COE. The degradation of the copolymer was performed according to the literature.

Consistent with the result from the homopolymerization, copolymers with ultra-high molecular weight and low dispersity (Mₙ=757 kg/mol, D=1.19) were generated, compared to the counterpart generated by free G3 at similar conversions (Mₙ=58 kg/mol, D=1.57). Furthermore, the copolymer generated by G3@UiO-67 incorporated 3-fold more DXP (0.74% vs. 0.24%), improving the degradability of the copolymer.

TABLE 3
Copolymerization of COE/DXP by G3@UiO-67 and G3

| | Time | | | | M_{n, SEC} | |
|---|---|---|---|---|---|---|
| Catalyst | (h) | Conv. | f_{DXP}⁰ | F_{DXP} | (kg/mol) | Ð |
| G3@UiO-67 | 24 | 9% | 10% | 0.74% | 757 | 1.19 |
| G3 | 3 | 11% | 10% | 0.24% | 58 | 1.57 |

TABLE 4
Degradation of poly(COE-co-DXP).

| | |
|---|---|
| Pristine copolymer | Degraded polymer |

| M_{n, SEC} | | M_{n, SEC} | |
|---|---|---|---|
| (kg/mol) | Ð | (kg/mol) | Ð |
| 757 | 1.19 | 46 | 3.48 |
| 58 | 1.57 | 28 | 1.93 |

TABLE 5
ROMP of cyclopentene by G3@UiO-67 and G3.

| | Time | | M_{n, SEC} | |
|---|---|---|---|---|
| Catalyst | (h) | Conv. | (kg/mol) | Ð |
| G3@UiO-67 | 24 | 32% | 532 | 1.40 |
| G3 | 24 | 29% | 67 | 3.60 |

### Depolymerization of Poly(Cyclopentene) by G3 and G3@UiO-67

For G3: To a vial containing a solution of G3 (0.29 μmol, 0.005 equiv.) in THF (26 μL), a solution of poly(cyclopentene) (2 mg, olefin content 29 μmol, 1 equiv.) in THF (267 μL) was added under N₂ atmosphere. For G3@UiO-67: In a N₂ glovebox, 14 mg of G3@UiO-67 (mass of catalyst was calculated based on Ru loading, 0.005 equiv.) was weighed out in a 2 mL glass vial with a PTFE stirring bar. 500 μL of THF was added into the vial and the encapsulated catalyst was thoroughly dispersed by vortex and sonication. The solid was precipitated down by centrifugation at 3000 rpm for 3 min and the supernatant was removed. A solution of poly(cyclopentene) (2 mg, olefin content 29 μmol, 1 equiv.) in THF (293 μL) was added followed by dispersing the encapsulated catalyst with vortex and sonication. The reaction mixture was stirred at 22° C. for 30 minutes and quenched by a drop of ethyl vinyl ether. A small portion (20 μL) of supernatant was taken out for analysis by ¹H NMR. The solvent in the rest of the supernatant was evaporated under vacuum the crude residue was analyzed by GPC.

### Synthesis of Poly(Vinyl Acetate-co-Ethylene)

907 kg/mol and 990 kg/mol: In a N₂ glovebox, G3@UiO-67 (1.05 g, 1 equiv.) was weighed out in a 20 mL glass vial with a PTFE stirring bar. 3 mL of toluene was added into the vial and the encapsulated catalyst was thoroughly dispersed by vortex and sonication. The solid was precipitated down by centrifugation at 3000 rpm for 10 min and the supernatant was removed. Toluene (7.5 mL) was added followed by dispersing the encapsulated catalyst with vortex and sonication. 3-acetoxy cyclooctene (3 g, 17.8 mmol, 1333 equiv.) was added at room temperature and the reaction mixture was stirred for 3 hours and quenched by 0.1 mL of ethyl vinyl ether. A small portion (20 μL) of supernatant was taken out for analysis by ¹H NMR (conversion=30%). The reaction mixture was diluted with 400 mL DCM, centrifuged at 12000 rpm for 10 min, filtered with 0.45 μm syringe filter, and precipitated into methanol (500*3 mL). The precipitated polymer was dried under vacuum for 12 hours, affording a white solid (yield=0.66 g, 21%). The condition of hydrogenation of the poly(3-acetoxy cyclooctene) was adopted from literature³, affording while to transparent solid (yield=0.62 g, 95%).

37 kg/mol and 30 kg/mol: The procedure was the same as the previous literature⁴, except that a different amount of cis-4-octene (13.3 mg, 118.1 μmol, 10 equiv.) was used. After hydrogenation, while to transparent solid was obtained (yield=1.35 g, 85%).

### Procedure for the “Split” Test

ROMP of cis-cyclooctene by G3@UiO-67 was set up following the procedure for the “polymerization of cis-cyclooctene”. After the reaction mixture was stirred for 120 min, a portion (30 μL) of the reaction mixture take out, filtered with a syringe filter (0.45 μm, PTFE), and divided into 2 parts, named “split mixture”. Meanwhile, another portion (15 μL) was taken out and quenched with ethyl vinyl ether. After the reaction mixture was stirred for 320 min and 1050 min, portions (15 μL) from both the original and “split” mixture were taken out and quenched with ethyl vinyl ether. Conversions were determined by ¹H-NMR.

Due to the low ceiling temperature of cyclopentene, polypentenamer can readily undergo depolymerization to generate cyclopentene under ambient conditions in the presence of metathesis catalysts. In addition, the low ring strain of cyclopentene and the high propensity for secondary metathesis further exacerbate the challenges for ROMP. It was postulated the MOF cage would serve as a physical barrier for the nascent polypentenamer to reaccess the catalyst and kinetically inhibit both the secondary metathesis and depolymerization during the ROMP of cyclopentene, allowing this reaction to become processive. Indeed, it was found that the depolymerization of a purified polypentenamer (Mₙ=355 kg/mol, D=1.91) was inhibited when it was incubated with G3@UiO-67 in a dilute solution (0.1 M in THF) at 22° C. In contrast, free G3 under the same condition led to fast depolymerization evidenced by ¹H NMR and SEC. Consistently, the ROMP of cyclopentene mediated by G3@UiO-67 yielded polypentenamer with ultra-high molecular weight and low dispersity (Mₙ=532 kg/mol, D=1.40) compared to the reaction mediated by free catalyst under the same condition (Mₙ=67 kg/mol, D=3.60).

Taken together, the stark contrast between the reactions mediated by the MOF-encapsulated catalysts and those that are mediated by the free catalysts confirmed that the MOF cage could serve as an effective physical barrier to inhibit the secondary metathesis in ROMP and promote processive polymerization in the ROMP of low-strain cyclic olefins.

Mechanical and adhesive properties of the polymer generated by MOF-encapsulated catalysts. Molecular weight profoundly impacts the mechanical and adhesive properties of polymers. High molecular weight polymers typically demonstrate higher toughness and stronger adhesion than their low molecular weight counterparts because of increased chain entanglements. It was envisioned that the processive ROMP mediated by MOF-encapsulated catalysts could be readily applied to producing ultra-high molecular weight polymers with improved mechanical and adhesive performance. To this end, the synthesis of ultra-high molecular weight poly(vinyl acetate-co-ethylene), p(VAE) was investigated via ROMP of 3-acetoxy cis-cyclooctene (3AcCOE), followed by hydrogenation to saturate the internal alkenes. It was demonstrated that ROMP of 3AcCOE could produce a regio-regular p(VAE) with an acetoxy group on every 8^{th} carbon on the backbone that is mechanically superior to the polymer produced through the free radical polymerization of ethylene and vinyl acetate or the coordination-insertion polymerization of these vinyl monomers. Using G3@UiO-67, an ultra-high molecular weight regio-regular p(VAE) (Mₙ=907 kg/mol, D=1.33) was synthesized via ROMP of 3AcCOE and hydrogenation, which is the highest molecular weight of p(VAE) recorded to date. After hydrogenation, this ultra-high molecular weight p(VAE) demonstrated typical thermoelastic behaviors with a strong strain hardening effect, achieving high ultimate stress (52±4 MPa), high strain (750±44%), and an overall toughness (181±24 MJ/m³) comparable to high-density polyethylene (HDPE) and isotactic polypropylene (iPP). Notably, these mechanical properties are markedly higher than those (33±2 MPa ultimate stress and 152±10 MJ/m³ toughness) of a lower molecular weight regio-regular p(VAE) synthesized by the free catalyst (Mₙ=37 kg/mol, D=2.10). It is noteworthy that the commercial random copolymer of vinyl acetate and ethylene with 50 wt % VAc incorporation, p(VAE50), demonstrated completely different mechanical properties as a ductile elastomer (9±0.3 MPa ultimate stress and 63±3 MJ/m³ toughness).

TABLE 6
Average stress at break, strain at break, toughness,
and Young's modulus values for poly(vinyl acetate-
co-ethylene) of varying molecular weights.

| | Average | Average | Average Young's | Average |
|---|---|---|---|---|
| M_{n, SEC} | Stress | Strain | modulus | Toughness |
| (kg/mol) | (MPa) | (%) | (MPa) | (MJ/m³) |
| 907 | 51.5 ± 4.4 | 749.5 ± 44 | 40.4 ± 7.1 | 181 ± 24 |
| 37 | 32.7 ± 1.5 | 839.0 ± 36 | 85.8 ± 16.6 | 152 ± 10 |

### Preparation of Polymer Film

Poly(vinyl acetate-co-ethylene) samples were placed in an open area of 70 mm.×13 mm of a stainless-steel mold between two stainless steel plates with aluminum foil sheets on the surface. The mold was then placed in a Carver press that was pre-heated to 100° C. and allowed to equilibrate for 5 min. To remove air bubbles from the samples, pressure was rapidly applied and released from the mold for 2 min. Immediately after, the mold was then placed under 2 metric tons of pressure for 5 min. The polymer was cooled to room temperature with water. The smooth, homogenous polymer film was removed from the mold, and dogbone-shaped samples were cut using an ASTM D638V cutting die press purchased from Pioneer DieTechs. The temperature of the press was set to 140° C. for PE and 190° C. for PP.

### Preparation of Samples for Lap Shear Test

The adhesive joint was obtained by pressing 30 mg of the copolymer between the stainless-steel plate at 165° C. under 1 ton for 5 min. The diameter of the joint was 2 mm×1 mm×1.21 mm. The sample was cooled to room temperature for 1 hour before measurement. 5 replications were performed for each sample.

TABLE 7
Average stress at break, strain at break, toughness, and
Young's modulus values for polyethylene, polypropylene,
and ethylene/vinyl acetate copolymer (VA content: 50 wt %).

| | Average | Average | Average Young's | Average |
|---|---|---|---|---|
| | Stress | Strain | modulus | Toughness |
| Polymer | (MPa) | (%) | (MPa) | (MJ/m³) |
| PE | 28.5 ± 3.3 | 1024 ± 121 | 811.8 ± 23.2 | 207 ± 37 |
| iPP | 35.0 ± 0.5 | 644.4 ± 19 | 992.7 ± 28.9 | 179 ± 6 |
| P(VAE50) | 9.3 ± 0.3 | 1871 ± 24 | 1.3 ± 1.0 | 63 ± 3 |

TABLE 8
Summary of stress at break, strain at break, toughness, and
Young's modulus values for poly(vinyl acetate-co-ethylene)
of varying molecular weights, polyethylene, polypropylene,
and ethylene/vinyl acetate copolymer (VA content: 50 wt %).

| | Stress | Strain | Young's modulus | Toughness |
|---|---|---|---|---|
| Polymer | (MPa) | (%) | (MPa) | (MJ/m³) |
| p(VAE) 907 kg/mol | 721.6 | 46.8 | 43.9 | 157.8 |
| p(VAE) 907 kg/mol | 833.6 | 59.5 | 45.9 | 225.3 |
| p(VAE) 907 kg/mol | 731.9 | 51.0 | 44.6 | 175.3 |
| p(VAE) 907 kg/mol | 709.0 | 48.3 | 26.6 | 160.3 |
| p(VAE) 907 kg/mol | 751.6 | 52.1 | 41.1 | 185.6 |
| p(VAE) 37 kg/mol | 824.5 | 32.1 | 85.5 | 171.4 |
| p(VAE) 37 kg/mol | 886.3 | 34.6 | 61.4 | 206.0 |
| p(VAE) 37 kg/mol | 872.5 | 33.8 | 100.3 | 189.5 |
| p(VAE) 37 kg/mol | 823.7 | 32.9 | 75.0 | 176.4 |
| p(VAE) 37 kg/mol | 788.1 | 30.2 | 107.1 | 221.0 |
| PE | 1017.1 | 28.4 | 800.5 | 160.5 |
| PE | 1177.4 | 32.6 | 790.8 | 145.6 |
| PE | 879.3 | 24.4 | 844.0 | 165.4 |
| iPP | 633.1 | 34.7 | 1019.5 | 162.2 |
| iPP | 628.5 | 34.7 | 1006.1 | 149.2 |
| iPP | 671.5 | 35.7 | 952.6 | 138.2 |
| p(VAE50) | 1837.4 | 8.9 | 2.7 | 207.1 |
| p(VAE50) | 1893.0 | 9.5 | 0.7 | 253.3 |
| p(VAE50) | 1883.4 | 9.6 | 0.6 | 162.0 |

TABLE 9
Glass transition temperature (T_{g}), melting temperatures
(Tₘ), crystallization temperature (T_{c}), and enthalpy
of melting and crystallization for poly(vinyl acetate-co-
ethylene) of varying molecular weights.

| | | | | Enthalpy of | Enthalpy of |
|---|---|---|---|---|---|
| M_{n, SEC} | T_{g} | Tₘ | T_{c} | melting | crystallization |
| (kg/mol) | (° C.) | (° C.) | (° C.) | (J/g) | (J/g) |
| 907 | −38.6 | 46.1 | −13.1 | 26.0 | 10.4 |
| 37 | −36.4 | 56.5 | nd | 43.7 | nd |

Note:
nd = not detected

TABLE 10
Temperatures at 5% (T_{d, 5%}) and 50% (T_{d, 50%}) mass loss
for poly(vinyl acetate-co-ethylene) of varying molecular
weights. Dynamic TGA measurements were taken at 10° C.
per minute from 25-600° C. under N₂ atmosphere.

| M_{n, SEC} | T_{d, 5%} | T_{d, 50%} |
|---|---|---|
| (kg/mol) | (° C.) | (° C.) |
| 907 | 312.3 | 449.8 |
| 37 | 317.4 | 444.9 |

TABLE 11
Lap shear strengths for poly(vinyl alcohol-co-vinyl acetate-
co-ethylene) of varying molecular, HDPE, and iPP weights.

| | Lap shear | Averaged Lap |
|---|---|---|
| Sample | strength (MPa) | shear strength (MPa) |
| p(VAVAE) 990 kg/mol | 0.99 | 1.12 ± 0.23 |
| p(VAVAE) 990 kg/mol | 0.87 | |
| p(VAVAE) 990 kg/mol | 1.23 | |
| p(VAVAE) 990 kg/mol | 1.52 | |
| p(VAVAE) 990 kg/mol | 0.97 | |
| p(VAVAE) 30 kg/mol | 0.12 | 0.17 ± 0.08 |
| p(VAVAE) 30 kg/mol | 0.13 | |
| p(VAVAE) 30 kg/mol | 0.30 | |
| p(VAVAE) 30 kg/mol | 0.21 | |
| p(VAVAE) 30 kg/mol | 0.10 | |
| HDPE | 0.026 | 0.057 ± 0.028 |
| HDPE | 0.035 | |
| HDPE | 0.087 | |
| HDPE | 0.095 | |
| HDPE | 0.045 | |
| iPP | 0.036 | 0.042 ± 0.026 |
| iPP | 0.028 | |
| iPP | 0.022 | |
| iPP | 0.030 | |
| iPP | 0.093 | |

Finally, the adhesive property of poly(vinyl acetate-co-vinyl alcohol-co-ethylene) (p(VAVAE)), generated by the partial deprotection of the regio-regular p(VAE), was measured by the lap shear test of a single-lap joint of polymer adhesive between two stainless steel slides. The ultra-high molecular weight p(VAVAE) (Mₙ=990 kg/mol, OH content: 18%) demonstrated 6.5-fold higher lap shear strength than the low molecular weight p(VAVAE) (Mₙ=30 kg/mol, OH content: 22%), with apparent lap shear strengths of 1.12±0.23 MPa and 0.17±0.08 MPa, respectively. This result further supports the strong chain entanglement of the ultra-high molecular polymer generated by the MOF-encapsulated catalyst than cannot be achieved by the low molecular weight counterpart produced by the free catalyst. Additionally, p(VAVAE)-990 kg/mol also exhibited significantly enhanced adhesion to stainless steel compared to either HDPE (0.057±0.028 MPa) or iPP (0.042±0.026 MPa), surpassing their adhesion strength by more than an order of magnitude.

In summary, a novel strategy was developed for processive ROMP using MOF-encapsulated catalysts. Ru-based olefin metathesis catalysts were efficiently encapsulated into MOF cages via the aperture-opening encapsulation method. The catalysts demonstrated excellent activities and size selectivity in a model RCM reaction, suggesting successful encapsulation into MOFs. ROMP of cis-cyclooctene and DXP exhibited high processivity and living characteristics when the MOF-encapsulated catalyst G3@UiO-67 was employed, leading to polymers with ultra-high molecular weight and low dispersity. ROMP of cyclopentene mediated by G3@UiO-67 achieved significantly higher molecular weight and lower dispersity than the counterpart mediated by the free catalyst. The ultra-high molecular weight polymers generated by the encapsulated catalysts demonstrated significantly improved mechanical and adhesive properties compared to the low molecular weight counterparts and commercial polymers. The simplicity and generality make this method readily applicable to the ROMP of a wide range of low-strain cyclic olefins. This work also revealed that molecular confinement is a promising strategy to reduce undesired chain transfer events in the polymerization mediated by other metalloorganic initiators.

### Example 5

### Recycled G3@UiO-67 for ROMP of Cis-Cyclooctene (COE)

In a N₂ glovebox, 15 mg of G3@UiO-67 (mass of catalyst was calculated based on Ru loading by ICP-OES, 1 equiv.) was weighed out in a 2 mL glass vial with a PTFE stirring bar. 500 μL of solvent of reaction was added into the vial and the encapsulated catalyst was thoroughly dispersed by vortex and sonication. The solid was precipitated down by centrifugation at 3000 rpm for 3 min and the supernatant was removed. A solution of 3-bromopyridine (55 μg, 0.35 μmol, 6 equiv.) in CDCl₃ (50 μL) was added to the vial, followed by dispersing the encapsulated catalyst with vortex and sonication. COE (15 μL, 115 μmol, 2000 equiv.) was added to the reaction at −10° C. The reaction mixture was stirred at −10° C. After 1 hour, a solution of cis-stilbene (1 equiv. to catalyst) in CDCl₃ (100 μL) was added to the reaction and the vial was centrifuged at 15000 rpm of 10 min at −10° C. The supernatant was transferred into a vial containing 5 μL ethyl vinyl ether and 100 μL CDCl₃. The same monomer solution of round 1 (15 μL of COE and 55 μg of 3-bromopyridine in 50 μL CDCl₃) was added under N₂ atmosphere. The reaction was stirred at −10° C. for 1 h. This procedure was repeated for another 2 rounds.

TABLE 12
ROMP of COE by fresh G3@UiO-67 (round
1) and recycled catalyst (round 2-4).

| | Time | | M_{n, SEC} | |
|---|---|---|---|---|
| Round | (h) | Conv. | (kg/mol) | Ð |
| 1 | 1 | 13% | 504 | 1.22 |
| 2 | 1 | 11% | 474 | 1.23 |
| 3 | 1 | 6% | 508 | 1.25 |
| 4 | 1 | 6% | 459 | 1.25 |

The MOF-encapsulated catalyst (G3@UiO-67) could be recycled by adding cis-stilbene at the end of the reaction, which could cleave the polymer chain from the Ru-chain end and reform Ru-carbene initiator. After the introduction of the cis-stilbene, the recycled G3@UiO-67 demonstrated a monomer conversion comparable to that of the fresh catalyst, yielding polyoctenamer with similar molecular weight and dispersity. Subsequent recycling cycles resulted in a modest decline in the activity of the catalyst, evident by reduced reaction kinetics. However, the polyoctenamers produced by the recycled catalysts still maintained similar molecular weight and dispersity as the polymers generated by the pristine catalysts.

### Polymerization of COE and Cyclopentene (CPE) by G3@UiO-67 in Microdroplets

To a 4 mL vial charged with G3@UiO-67 (the mass of the MOF-encapsulated catalyst was calculated based on the Ru loading measured by ICP-OES, 1 equiv.) and a PTFE stirring bar. 500 μL of toluene was added into the vial and the encapsulated catalyst was thoroughly dispersed by vortex and sonication. The solid was precipitated down by centrifugation at 3000 rpm for 3 min and the supernatant was removed. 50 μL of toluene and 40 μL of hexadecane was added to the solid. The mixture was sonicated for 1 min, followed by the addition of 0.5 mL of sodium dodecyl sulfate aqueous solution (5 mg/mL). The mixture was sonicated for 5 min before the addition of COE (12.5 μL, 2000 equiv.) or CPE (37.5 μL, 4000 μL). The reaction mixture was stirred for 2 h for COE or 4 h for CPE at 22° C. The reaction was quenched by 5 μL drop of ethyl vinyl ether in 100 μL CHCl₃ and 30 μL of the reaction mixture was taken out and added to a vial containing 500 μL of CDCl₃. The vial was shaken violently, and the organic phase was transferred to an NMR tube for conversion determination (EVE as internal standard). The reaction mixture was poured into methanol (15 mL) and the polymer and MOF were precipitated down by centrifugation at 3000 RPM for 10 min. After the supernatant was decanted, 10 mL of CHCl₃ was added to dissolve the polymer. Then the MOF was precipitated down by centrifugation at 3000 rpm for 10 min. The supernatant was transferred to a 20 mL vial and the solvent was removed under reduced pressure. The residue was submitted to NMR or GPC for analysis.

Emulsion ROMP of COE mediated by G3@UiO-67 that was compartmentalized in microdroplets exhibited consistently low viscosity over the course of the reaction and reached 84% monomer conversion within 2 hours. An ultra-high molecular weight polyoctenamer with Mₙ of 1146 kg/mol and D of 1.13 was produced from this reaction. Likewise, emulsion ROMP of CPE mediated by the microdroplet-compartmentalized G3@UiO-67 was also significantly faster, reaching 63% monomer conversion within 4 hours and producing a ultra-high molecular weight polypentenamer with Mₙ of 722 kg/mol and D of 1.19

Chain Extension of p(COE)

In a N₂ glovebox, 14.6 mg of G3@UiO-67 (mass of the MOF-encapsulated catalyst was calculated based on Ru loading measured by ICP-OES, 1 equiv.) was weighed out in a 2 mL glass vial with a PTFE stirring bar. 500 μL of solvent of reaction was added into the vial and the encapsulated catalyst was thoroughly dispersed by vortex and sonication. The solid was precipitated down by centrifugation at 3000 rpm for 3 min and the supernatant was removed. COE (2 μL, 15.4 μmol, 280 equiv.) was added to the reaction at −10° C. The reaction mixture was stirred at −10° C. Two parallel reactions were set up together and one of the reactions was quenched with one drop of ethyl vinyl ether after 30 h. A solution of COE (15 μL, 115 μmol, 2100 equiv.), and 3-bromopyridine (36.4 μg, 0.23 μmol, 4.2 equiv.) in CDCl₃ (35 μL) was added to the other reaction and the reaction mixture was stirred at −10° C. for 20 h, followed by quenching with one drop of ethyl vinyl ether. The reaction mixture was diluted with CDCl₃ (0.5 mL) and the solid was precipitated down (10000 rpm, 5 min). A small portion (20 μL) of supernatant was taken out for analysis by ¹H NMR. The rest of the supernatant was concentrated and precipitated into 2 mL of MeOH. The precipitation redissolved and precipitated again and the polymer was analyzed by GPC and ¹H NMR.

The catalyst-associated polymer chain end remained living after the quantitative monomer conversion was reached. When additional COE was added into the reaction, chain extension successfully produced an extended polyoctenamer product with >10-fold higher molecular weight and lower D.

TABLE 13
Chain extension of p(COE).

| | Time | | M_{n, SEC} | |
|---|---|---|---|---|
| | (h) | Conv. | (kg/mol) | Ð |
| 1^{st} block | 30 | 75% | 54 | 2.65 |
| 1^{st} + 2^{nd} block | 20 | 39% | 601 | 1.31 |

All references cited herein are incorporated herein by reference in their entireties. It will be appreciated by persons skilled in the art that the present invention is not limited to what has been particularly shown and described. Rather, the scope of the present invention is defined by the claims which follow. It should further be understood that the above description is only representative of illustrative examples of embodiments. The description has not attempted to exhaustively enumerate all possible variations. The alternate embodiments may not have been presented for a specific portion of the invention, and may result from a different combination of described portions, or that other un-described alternate embodiments may be available for a portion, is not to be considered a disclaimer of those alternate embodiments. It will be appreciated that many of those un-described embodiments are within the literal scope of the following claims, and others are equivalent.

We claim:

1. A caged catalyst for catalyzing a reaction, comprising a catalyst encapsulated in a cage compound represented by [Zr^{IV}₆O₄(OH)₄(linker)₆]).

2. The caged catalyst of claim 1, wherein the linker is selected from benzene 1,4-dicarboxylic acid, 4,4′-biphenyl-dicarboxylic acid, 4,4″-terphenyl-dicarboxylic acid, 2 2′-bipyridine-5 5′-dicarboxylic acid, 2,2′-dimethyl-[1,1′-biphenyl]-4,4′-dicarboxylic acid, 3,3′-dihydroxy-[1,1′-biphenyl]-4,4′-dicarboxylic acid, 2-amino-[1,1′-biphenyl]-4,4′-dicarboxylic acid, and 2,2′-dinitro-[1,1′-biphenyl]-4,4′-dicarboxylic acid.

3. The caged catalyst of claim 1, wherein the linker is 2 2′-bipyridine-5 5′-dicarboxylic acid.

4. The caged catalyst of claim 1, wherein the linker is 4,4′-biphenyl-dicarboxylic acid.

5. The caged catalyst of claim 1, wherein the catalyst provides at least 50% conversion of a monomer alkene substrate.

6. The caged catalyst of claim 1, wherein the catalyst is a Ruthenium-based catalyst.

7. The caged catalyst of claim 1, wherein the catalyst is selected from the group consisting of

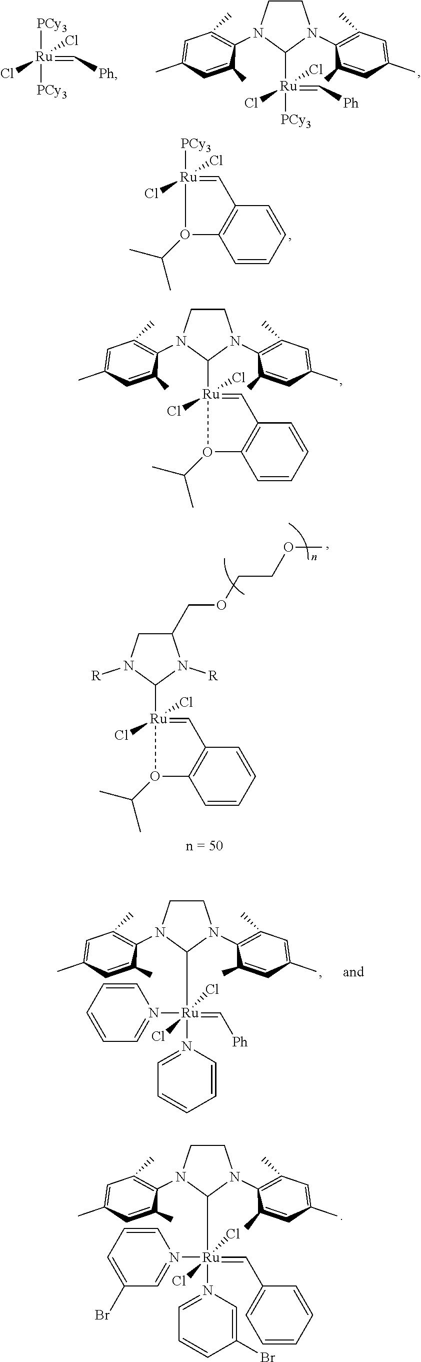

8. The caged catalyst of claim 1, wherein the catalyst is

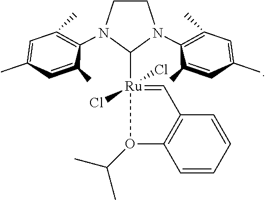

9. The caged catalyst of claim 1, wherein the catalyst comprises Ruthenium, wherein the Ruthenium ranges from about 0.01% to about 0.5% by weight over the total weight of the caged catalyst.

10. The caged catalyst of claim 1, wherein the caged catalyst exhibits stronger resistency to tertiary amines by at least 10 folds over a reference catalyst without being encapsulated in the cage compound.

11. A method of synthesizing a polymer, comprising contacting a caged catalyst of claim 1 with one or more cyclic alkenes in a liquid phase.

12. The method of claim 11, wherein at least one of one or more cyclic alkenes contains at least five ring members.

13. The method of claim 11, wherein the one or more cyclic alkenes contains at least two cyclic alkenes.

14. The method of claim 11, further comprising adding to the liquid phase an exogenous ligand to suppress dissociation of catalyst ligand.

15. The method of claim 11, which produces the polymer in a molecular weight of at least 800 k daltons.

16. The method of claim 11, which produces the polymer in a dispersity (D) of less than 1.50.

17. The method of claim 11, wherein the one or more cyclic alkenes comprise an alkylcyclyl alkene and a heterocyclyl alkene, wherein the caged catalyst increases incorporation of the heterocyclyl alkene by more than 50% in the polymer comparing with a reference catalyst not encapsulated in the cage compound.

18. The method of claim 11, wherein the caged catalyst increases one or more of ultimate stress, strain, overall toughness, and lap shear strength of the polymer in comparison with a reference catalyst.

19. A method of preparing the caged catalyst of claim 1, comprising
(a) mixing the catalyst and the cage compound in a first polar solvent;
(b) removing partially or completely the acetonitrile to collect a solid; and
(c) mixing the solid with a second polar solvent or a nonpolar solvent.

20. The method of claim 19, wherein the first polar solvent is acetonitrile.
